(19) United States
(12) Patent Application Publication
(10) Pub. No.: US 2020/0103336 A1
(43) Pub. Date: Apr. 2, 2020

(54) MICROLENS ARRAY, OPTICAL DETECTING DEVICE AND METHOD FOR PREPARING MICROLENS ARRAY

(71) Applicant: SHENZHEN INSTITUTES OF ADVANCED TECHNOLOGY, Nanshan Shenzhen, Guangdong (CN)

(72) Inventors: Hui YANG, Nanshan Shenzhen, Guangdong (CN); Yi ZHANG, Nanshan Shenzhen, Guangdong (CN)

(73) Assignee: SHENZHEN INSTITUTES OF ADVANCED TECHNOLOGY, Nanshan Shenzhen, Guangdong (CN)

(21) Appl. No.: 16/621,863

(22) PCT Filed: Dec. 26, 2017
(86) PCT No.: PCT/CN2017/118517

§ 371 Date: Dec. 12, 2019

(51) Int. Cl. G01N 21/01; G02B 3/00

(52) U.S. Cl. CPC G01N 21/01; G01N 2201/0639; G02B 3/0075

(57) ABSTRACT

An optical detecting device for detecting a nanoscale object, comprising: a microfluidic device, a microlens array, a light source and a light detecting element, wherein the microfluidic device comprises a top wall and a bottom wall arranged oppositely and a microfluidic channel between the top wall and the bottom wall; the microlens array is arranged on a surface of the bottom wall, and the bottom wall is made of an optically transparent material, and the light source is arranged on the surface of the bottom wall away from the microlens array aligned to the microlens array; the beam of the light source causes the formation of a photonic nanojet area in the microfluidic channel; the light detecting element receives light from the photonic nanojet area to detect the nanoscale object arranged in the photonic nanojet area.

### FIELD OF THE INVENTION

The present invention relates to optical detecting technology and more particularly to microlens array, optical detecting device and method for preparing microlens array.

### BACKGROUND OF THE INVENTION

Compared with traditional size scale materials, nanoscale materials have become indispensable to the applications of traditional materials, medical device, electronic device and coating materials due to their unique physical and chemical properties. Correspondingly, devices and technologies for detecting and imaging nanomaterials are becoming more and more important, and have attracted great attention from researchers.

At present, a conventional optical microscope is commonly used for imaging objects on a traditional size scale. However, resolution of a conventional optical microscope can only reach half the wavelength of the incident light (about 200 nm) due to the diffraction limit. Many important substances, such as microorganisms, bacteria, viruses, proteins in the fields of medicine and biology, cannot be detected and characterized in real time by a conventional optical microscope. An existing optical imaging device or technology that can break through the diffraction limit is typically based on bulky and expensive device or requires complex manufacturing processes to introduce photon structure, making it difficult to apply on a large scale.

### SUMMARY OF THE INVENTION

The present invention aims to provide an optical detecting device for detecting and characterizing nanoscale objects.

The invention further provides a microlens array and a method for preparing microlens array.

The microlens array of the present invention comprises:

a substrate,

a microwell array arranged on the substrate, the microwell array comprising a plurality of microwells, and

a microsphere lens arranged in the microwells;

wherein the substrate is made of an optically transparent material and the microwell array is made of a hydrophobic material.

The optical detecting device of the present invention is configured to detect a nanoscale object. The device comprises:

a microfluidic device, a microlens array, a light source and a light detecting element,

wherein the microfluidic device comprises a top wall and a bottom wall arranged oppositely and a microfluidic channel between the top wall and the bottom wall, and

wherein the microlens array is arranged on a surface of the bottom wall, and the bottom wall is made of an optically transparent material, and

wherein the light source is arranged on the surface of the bottom wall away from the microlens array and aligned to the microlens array, the beam of the light source causes the formation of a photonic nanojet area in the microfluidic channel, and

wherein the light detecting element receives light from the photonic nanojet area to detect the nanoscale object arranged in the photonic nanojet area.

In an embodiment, the optical detecting device comprises a moving portion for moving the microlens array relative to the top wall of the microfluidic channel.

In an embodiment, the microsphere lens of the microlens array is fixed in the microwells due to the electrostatic adsorption.

In an embodiment, the microwells have the same size as the microsphere lens, and one microsphere lens is assembled in each of the microwells.

In an embodiment, a distance from a surface of the microsphere lens to the top wall is larger than a dimension of the photonic nanojet area perpendicular to the bottom wall.

In an embodiment, the light source includes, but is not limited to, one of a white light source, a fluorescent light source and a laser light source.

In an embodiment, the light detecting element includes, but is not limited to, one of a sensor, a charge coupled device camera, a spectrometer, a complementary metal oxide semiconductor sensor, a photomultiplier tube device and a photonic avalanche diode.

A method for preparing microlens array of the present invention comprises:

providing a substrate made of an optically transparent material;

forming a hydrophobic layer on the substrate;

processing the hydrophobic layer into a microwell array comprising a plurality of microwells;

assembling a microsphere lens in each of the microwells.

In an embodiment, the optically transparent material is a hydrophilic material, including, but not limited to, one of glass, silicon and silicon oxide.

In an embodiment, the step of processing the hydrophobic layer into a microwell array comprises performing one of photolithography, evaporation and plasma etching to process the microwells.

The optical detecting device of the invention integrates a microlens array into the microfluidic device. Detection and imaging of the nanoscale objects in the photonic nanojet area in the microfluidic channel are performed taking advantage of a photonic nanojet generated from the microsphere lens subjecting to the light source, thereby realizing real-time detection and characterization of nanoscale objects. This greatly reduces the manufacturing difficulty and manufacturing cost of apparatus for detecting nanoscale objects and can be widely applied to different applications.

### BRIEF DESCRIPTION OF THE DRAWINGS

To illustrate the technical solutions in the embodiments of the present invention or in the prior art more clearly, the following briefly introduces the accompanying drawings required for describing the embodiments or the prior art. As is apparent, the accompanying drawings in the following description show merely some embodiments of the present invention, and a person of ordinary skill in the art may still derive other drawings from these accompanying drawings without creative efforts.

FIG. 1 shows the structure of a microlens array in accordance with the present invention.

FIG. 2 shows the structure of an optical detecting device in accordance with the present invention.

FIG. 3 is an image of a 46 nm object detected by the optical detecting device shown in FIG. 2.

FIG. 4 is an image of a 20 nm object detected by the optical detecting device shown in FIG. 2.

FIG. 5 is a flow chart of a method for preparing a microlens array in accordance with the present invention.

### DETAILED DESCRIPTION OF THE INVENTION

The following clearly describes the technical solutions in the embodiments of the present invention with reference to the accompanying drawings in the embodiments of the present invention. As is apparent, the described embodiments are merely a part rather than all of the embodiments of the present invention. All other embodiments obtained by a person of ordinary skill in the art based on the embodiments of the present invention without creative efforts shall fall within the protection scope of the present invention.

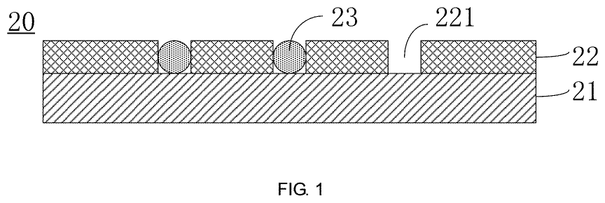

Referring to FIG. 1, a preferred embodiment of the present invention provides a microlens array 20 comprising a substrate 21, a microwell array 22 arranged on the substrate 21, the microwell array 22 comprising a plurality of microwells 221, and a microsphere lens 23 arranged in the microwells 221; wherein the substrate 21 is made of an optically transparent material and the microwell array 22 is made of a hydrophobic material. In this embodiment, the substrate 21 of the microlens array 20 is a glass chip and the microwell array 22 is made of a hydrophobic material; the microsphere lens 23 is a microsphere lens made of a dielectric material. The microsphere lens 22 is fixed in the microwells 221 due to the hydrophilicity of the glass chip and electrostatic adsorption between the hydrophobic material and the dielectric material. Specifically, the size of the microwells 221 is the same as the diameter of the microsphere lens 23, and one microsphere lens 23 is assembled in each of the microwells 221, and the position of the microsphere lens 23 is not shifted. In such embodiment, the hydrophobic material comprises an organic material such as parylene, perfluoro cyclic polymer (CYTOP) or polydimethylsiloxane (PDMS); the dielectric material comprises a material having a refractive index greater than that of water, such as silicon dioxide, titanium dioxide, lead zirconate titanate or lead barium titanate. It can be understood that, in other embodiments, the substrate 21 may be selected from silicon, silicon oxide or an optically transparent material subjected to a surface chemical treatment; the microsphere lens 23 may be a microlens structure fabricated by a micromachining process.

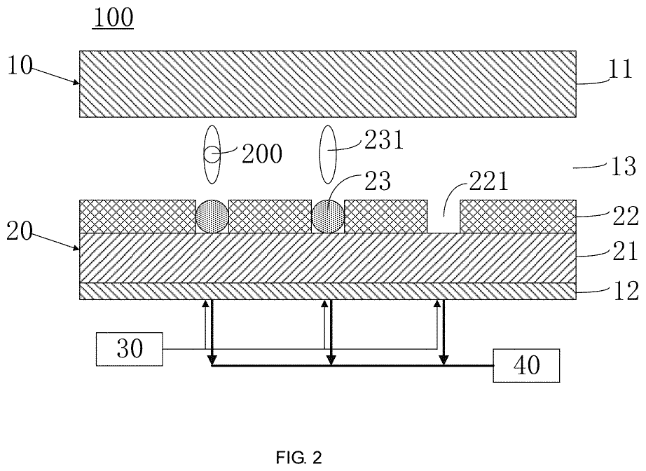

Referring to FIG. 2, the present invention further provides an optical detecting device 100 for optically detecting and imaging a sub-diffraction-limited nanoscale object 200. The optical detecting device 100 comprises a microfluidic device 10, a microlens array 20, a light source 30 and a light detecting element 40. In this embodiment, the microfluidic device 10 comprises a top wall 11 and a bottom wall 12 arranged oppositely, and a microfluidic channel 13 between the top wall 11 and the bottom wall 12; the microlens array 20 is arranged on a surface of the bottom wall 12, and the substrate 21 of the microlens array 20 is arranged on the bottom wall 12. The substrate 21 and the bottom wall 12 are made of an optically transparent material. The microsphere lens 23 is fixed in the microwells 221 and is in contact with the substrate 21; the light source 30 is arranged on the surface of the bottom wall 12 away from the microlens array 20 and aligned to the microlens array 20. The light source 30 is arranged to provide illumination for the microsphere lens 23 to form a photonic nanojet area 231 in the microfluidic channel 13. The light detecting element 40 receives the light from the photonic nanojet area 231 to detect the nanoscale object 200 arranged in the photonic nanojet area 231. In this embodiment, the optical detecting device 100 further comprises a moving portion (not shown) for moving the microlens array 20 relative to the top wall 11. That is, the moving portion can shift while carrying the microlens array 20 or the top wall 11 opposite thereto, thereby implementing a continuous scan of the entire microfluidic channel 13 by the microlens array 20.

The optical detecting device of the invention integrates a microlens array into the microfluidic device, and uses a microsphere lens having high refractive index to focus the light from the light source and form a sub-diffraction-limited photonic nanojet area. When a nanoscale object passes through the photonic nanojet area, the microsphere lens amplifies the optical signal and images the nanoscale object. The optical signal is captured and recorded by the light detecting element. The obtained data is then analyzed and restored, thereby realizing real-time detection and characterization of the nanoscale object.

In this embodiment, the substrate 21 of the microlens array 20 is a glass chip, and the microwell array 22 is made of a hydrophobic material, and the microsphere lens 23 is a microsphere lens made of a dielectric material. The microsphere lens 22 is fixed in the microwells 221 due to the hydrophilicity of the glass chip and electrostatic adsorption between the hydrophobic material and the dielectric material. Specifically, the size of the microwells 221 is the same as the diameter of the microsphere lens 23, and one microsphere lens 23 is assembled in each of the microwells 221, and the position of the microsphere lens 23 is not shifted, which is beneficial for the light source 30 to precisely align each of the microsphere lenses 23 and form a photonic nanojet flow area 231 above each of the microsphere lenses 23. In this embodiment, the light source includes, but is not limited to, one of a white light source, a fluorescent light source or a laser light source.

The microlens array 20 is arranged in the microfluidic device 10. In this embodiment, the microfluidic device 10 is made of an organic material, and the microfluidic channel 13 is fabricated by processing the organic material using a micromachining method, and the height dimension of the microfluidic channel 13 remains substantially the same as the longitudinal dimension of the photonic nanojet area 231. Specifically, a distance from a surface of the microsphere lens 23 to the top wall 11 is larger than a dimension of the photonic nanojet area 231 perpendicular to the bottom wall 12. When the distance from a surface of the microsphere lens 23 to the top wall 11 is equal to or smaller than three times the dimension of the photonic nanojet area 231 perpendicular to the bottom wall 12, the light detecting element 40 can detect the nanoscale objects within the nanojet area 231 more sensitively. In this embodiment, the height dimension of the microfluidic channel 13 can be controlled by adjusting the micromachining process. Alternatively, it is possible to control the height in the micromachining process by using spacer particles of different sizes, which are made of a material having a relatively high hardness, such as SiO₂ particles, etc. The light detecting element 40 includes, but is not limited to, one of a sensor, a charge coupled device camera, a spectrometer, a complementary metal oxide semiconductor sensor, a photomultiplier tube device and a photonic avalanche diode.

When the optical detecting device 100 is used to detect nanoscale object 200, the light from the light source 30 is directed onto the microlens array 20, and each of the microsphere lenses 23 focuses the received light on a sub-diffraction limited area, forming a plurality of the photonic nanojet area 231 in the microfluidic channel 13. Fluid medium carrying dispersed nanoscale objects 200 to be tested is introduced into the microfluidic channel 13. When a single nanoscale object 200 to be tested passes through the photonic nanojet area 231, the optical signal intensity of the photonic nanojet area 231 will greatly enhance and an enlarged virtual image will be presented in the optical far field due to the high electromagnetic field strength of the photonic nanojet area 231, size of the sub-diffraction limited area and its high sensitivity to the light field disturbance. The light detecting element 40 records the optical signal and image, and analyzes and restores the obtained data, thereby confirming the presence of the nanoscale object 200 in the fluid medium and obtaining parameters such as size. In this embodiment, the fluid medium introduced into the microfluidic channel 13 includes, but is not limited to, one of a liquid medium, a gaseous medium and a gas-liquid mixed medium.

It can be understood that, according to classical fluid dynamics, when the flow of the fluid medium in the microfluidic channel 13 is pressure driven, the flow pattern of the fluid medium along the depth of the fluid channel 23 has a parabolic fluid velocity profile. When the nanoscale object 200 to be tested is fixed on the top wall 11 of the microfluidic channel 13 or the nanoscale object 200 to be tested is the top wall 11 of the microfluidic channel 13, the top wall 11 is movable relative to the microlens array 20 by the moving portion, whiling carrying the nanoscale object 200 through the photonic nanojet area 231 for detecting. Alternatively, the microlens array 20 may perform a continuous scan on the top wall 11 to which the nanoscale object 200 is fixed, with the assistance of the moving portion. Images corresponding to different locations are recorded and an image reconstruction algorithm is used to obtain a complete image covering the entire sample area.

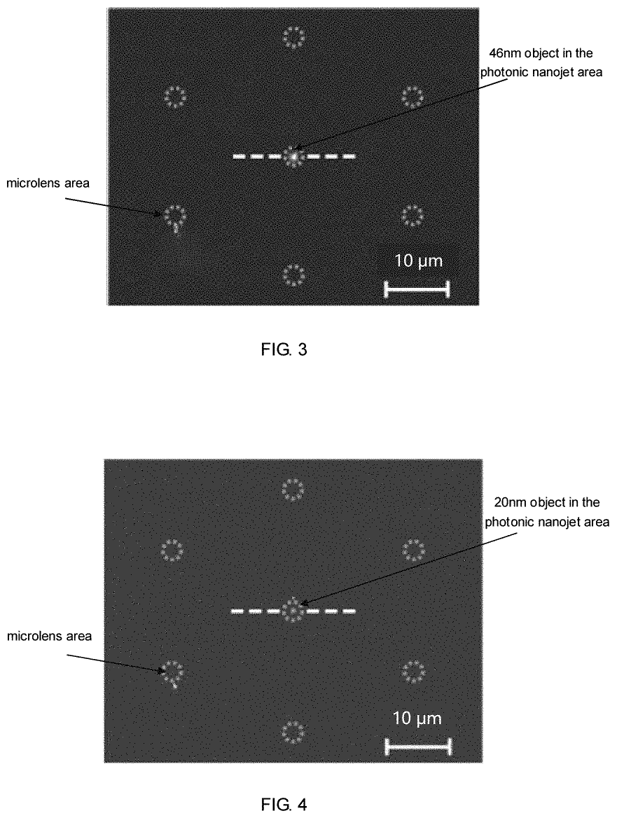

The images of objects of different size detected by the optical detecting device are shown in FIGS. 3 and 4.

By using only one set of apparatus integrating microlens arrays with microfluidic device, the optical detecting device of the invention realizes characterization of the sub-diffraction limited nanoscale objects due to the photonic nanojet and greatly reduces the manufacturing difficulty and manufacturing cost. Furthermore, the presence of the microlens array in the optical detecting device of the present invention enables the optical detecting device to characterize a plurality of nanoscale objects, greatly improving efficiency.

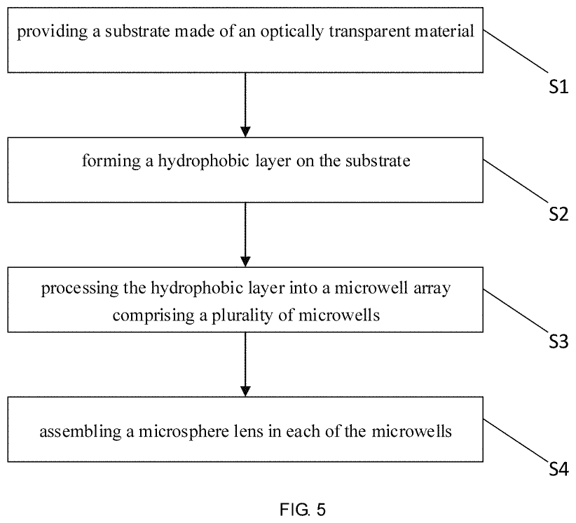

Referring to FIG. 5, the present invention further provides a method for preparing a microlens array for preparing a high-precision microlens array. The method comprises the following steps.

At step S1, a substrate made of an optically transparent material is provided. In this embodiment, a glass chip is used as the substrate of the microlens array. In other embodiments, a hydrophilic optically transparent material such as silicon or silicon oxide may be used.

At step S2, a hydrophobic layer is formed on the substrate. The hydrophobic layer is made of a hydrophobic material deposited on the substrate. The hydrophobic material includes, but is not limited to, one of hydrophobic organic materials such as parylene, perfluoro cyclic polymer and polydimethylsiloxane. The deposition method includes, but is not limited to, one of chemical deposition method and plasma deposition method.

At step S3, the hydrophobic layer is processed into a microwell array comprising a plurality of microwells. On the hydrophobic layer a plurality of microwells are machined by micromachining. The size and position of the microwells are precisely controlled during micromachining process. The micromachining process includes, but is not limited to, one of photolithography, chemical vapor deposition, atomic layer deposition, magnetron sputtering, metal evaporation, plasma etching, dry etching and wet etching. In this embodiment, the arrangement of the microwells in the microwell array is not specifically limited. For example, the microwells can be arranged in the form of a matrix, a densely arranged honeycomb, a ring or a disordered form, etc.

At step S4, a microsphere lens is assembled in each of the microwells. In this embodiment, the microsphere lens is made of a dielectric material having a higher refractive index than water. The dielectric material includes, but is not limited to, one of the materials such as silicon dioxide, titanium dioxide, lead zirconate titanate, lead barium titanate, and the like. The microsphere lens is assembled in the microwells taking advantage of the hydrophilicity of the substrate. In this embodiment, the microsphere lens is fixed in the microwells by adjusting the size of the microsphere lens and the microwells and utilizing electrostatic adsorption between the dielectric material and the hydrophobic material. The size of the microwells is precisely controlled during micromachining process such that its diameter coincides with the diameter of the microsphere lens. Only one microsphere lens is assembled in each of the microwells, and each microsphere lens is not shifted, which is beneficial for the light source to precisely align each of the microsphere lenses in the microwells. It can be understood that the microsphere lens can also be a microlens structure fabricated by a micromachining process.

The method for preparing microlens array of the present invention strictly controls the size and position of the microwells by using a micromachining process, so that the diameter of the microwells in the microlens array is consistent with that of the microsphere lens. The hydrophilicity of the substrate material and the electrostatic adsorption between the hydrophobic layer and the microsphere lens material causes each microsphere lens to be fixed in the microwells, and the microsphere lens is not shifted, which improves the precision of the microlens array.

The foregoing descriptions are merely specific embodiments of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

1. A microlens array, comprising:
a substrate,
a microwell array arranged on the substrate, the microwell array comprising a plurality of microwells, and
a microsphere lens arranged in the microwells;
wherein the substrate is made of an optically transparent material, and the microwell array is made of a hydrophobic material.

2. An optical detecting device for detecting a nanoscale object, comprising:
a microfluidic device, a microlens array, a light source, and a light detecting element;
wherein the microfluidic device comprises a top wall and a bottom wall arranged oppositely and a microfluidic channel between the top wall and the bottom wall, and
wherein the microlens array is arranged on a surface of the bottom wall, and the bottom wall is made of an optically transparent material, and
wherein the light source is arranged on the surface of the bottom wall away from the microlens array and aligned to the microlens array, the beam of the light source causes the formation of a photonic nanojet area in the microfluidic channel, and
wherein the light detecting element receives light from the photonic nanojet area to detect the nanoscale object arranged in the photonic nanojet area.

3. The optical detecting device according to claim 2 further comprising a moving portion for moving the microlens array relative to the top wall.

4. The optical detecting device according to claim 2, wherein the microsphere lens of the microlens array is fixed in the microwells due to the electrostatic adsorption.

5. The optical detecting device according to claim 4, wherein the microwells have the same size as the microsphere lens, and one microsphere lens is assembled in each of the microwells.

6. The optical detecting device according to claim 5, wherein a distance from a surface of the microsphere lens to the top wall is larger than a dimension of the photonic nanojet area perpendicular to the bottom wall.

7. The optical detecting device according to claim 2, wherein the light source comprises one of a white light source, a fluorescent light source and a laser light source.

8. The optical detecting device according to claim 2, wherein the light detecting element comprises one of a charge coupled device camera, a spectrometer, a complementary metal oxide semiconductor sensor, a photomultiplier tube device and a photonic avalanche diode.

9. A method for preparing a microlens array, comprising:
providing a substrate made of an optically transparent material;
forming a hydrophobic layer on the substrate;
processing the hydrophobic layer into a microwell array comprising a plurality of microwells;
assembling a microsphere lens in each of the microwells.

10. The method according to claim 9, wherein the step of processing the hydrophobic layer into a microwell array comprising a plurality of microwells comprises performing one of photolithography, evaporation and plasma etching to process the microwells.
